(19) United States
(12) Patent Application Publication
(10) Pub. No.: US 2022/0194145 A1
(43) Pub. Date: Jun. 23, 2022

(54) TIRE AND WHEEL ASSEMBLY INCLUDING THE SAME

(71) Applicant: Nexen Tire America Inc., Diamond Bar, CA (US)

(72) Inventor: Aaron Neumann, Hudson, OH (US)

(21) Appl. No.: 17/129,896

(22) Filed: Dec. 21, 2020

(51) Int. Cl. B60C 13/02

(52) U.S. Cl. CPC B60C 13/02

(57) ABSTRACT

A tire mountable on a vehicle wheel includes: a tread section; and a tire side section to be mounted on the vehicle wheel, the tire side section being continuous with the tread section. The tire side section includes: a first area extending in a circumferential direction with substantially equal radii from an axis of the tire and being adjacent to the tread section; and a second area extending in the circumferential direction with substantially equal radii from the axis of the vehicle wheel and disposed between the first area and the vehicle wheel. The second area includes discontinuous recesses in an outer surface of the tire side section.

### BACKGROUND

### Field

Exemplary implementations of the invention relate generally to a tire and a wheel assembly including the same, and more specifically, to a tire and a wheel assembly including the same having a tread section and a tire side section continuous with the tread section.

### Discussion of the Background

A vehicle includes tires contacting the ground, and moves and stops using the tire. The tires may be mounted on the vehicle through rim wheels. The tires may have widths greater than those of the rim wheels to protect the rim wheels from the external environment.

Aerodynamic drag may occur on various components of the vehicle when the tires roll to move the vehicle. Accordingly, it is necessary to reduce the aerodynamic drag to move the vehicle efficiently especially at relatively high speeds. Such an aerodynamic drag may also occur on the tires and the rim wheels. To reduce the aerodynamic drag on the tires and the rim wheels, the air needs to flow along surfaces of the tires and the rim wheels.

The above information disclosed in this Background section is only for understanding of the background of the inventive concepts, and, therefore, it may contain information that does not constitute prior art.

### SUMMARY

Applicant discovered that air flow around a tire is separated from a curved side surface of the tire when the tire rolls to move a vehicle, which may cause a low air pressure area around the tire.

Tires and wheel assemblies constructed according to the principles and exemplary implementations of the invention are capable of reducing aerodynamic drag on the tires, the wheel assemblies including the tires, and vehicles including the wheel assemblies. For example, a tire may have a recessed outer surface adjacent to a rim wheel to reduce a low air pressure area occurring around the tire and/or the rim wheel when the tire rolls to move.

Additional features of the inventive concepts will be set forth in the description which follows, and in part will be apparent from the description, or may be learned by practice of the inventive concepts.

According to one aspect of the invention, a tire mountable on a vehicle wheel includes: a tread section; and a tire side section to be mounted on the vehicle wheel, the tire side section being continuous with the tread section. The tire side section includes: a first area extending in a circumferential direction with substantially equal radii from an axis of the tire and being adjacent to the tread section; and a second area extending in the circumferential direction with substantially equal radii from the axis of the vehicle wheel and disposed between the first area and the vehicle wheel. The second area includes discontinuous recesses in an outer surface of the tire side section.

The discontinuous recesses may be formed in the second area without extending in the circumferential direction and in a radial direction of the tire, and the discontinuous recesses may move a point of flow separation on the outer surface towards the vehicle wheel when the tire rolls to move.

The discontinuous recesses may include dimpled patterns.

Each of the dimpled patterns may include one of a polygon and a circle.

The dimpled patterns may be arranged in the second area in the circumferential direction and a radial direction of the tire.

The first area may extend from the tread section to the second area and may have a substantially smooth surface.

The tire side section may have a tire width in a width direction of the tread section at a point of the first area, and the tire width may increase as a distance between the point of the first area and the vehicle wheel decreases.

The first area may extend from the tread section to the second area and may include a protrusion having a height of about 1 millimeter or less.

The tire side section may further include an interface area to be mounted on the vehicle wheel, and the the second area may be adjacent to the interface area without an intervening area.

The tire side section may have a tire width in a width direction of the tread section at a point of the second area, and the tire width may decrease as a distance between the point of the second area and the vehicle wheel decreases.

The tire side section may have a first width in a radial direction of the tire, the first area have a second width in the radial direction, the second area may have a third width in the radial direction, the second width may be in a range of about 25% to about 55% of the first width, and the third width may be in a range of about 25% to about 55% of the first width.

The tire side section may include a pair of sidewalls, and at least one of the sidewalls may include the first area and the second area.

According to another aspect of the invention, a wheel assembly for a vehicle includes a wheel and a tire mounted on the wheel. The tire includes: a tread section; and a tire side section mounted on the wheel, the tire side section being continuous with the tread section. The tire side section includes: a first area extending in a circumferential direction of the tire with substantially equal radii from an axis of the wheel and being adjacent to the tread section; and a second area extending in the circumferential direction with substantially equal radii from the axis of the wheel and disposed between the first area and the wheel, the second area including discontinuous recesses in an outer surface of the tire side section.

The tire side section may have a tire width in a width direction of the tread section at a point of the second area, the tire width decreasing as a distance between the point of the second area and the wheel decreases. The wheel may have a wheel width in the width direction, the wheel width being less than the tire width.

The discontinuous recesses may be formed in the second area without extending in the circumferential direction and in a radial direction of the tire to reduce a low pressure area caused by the wheel width less than the tire width when the wheel assembly rolls to move.

The tire side section may have a first width in a radial direction of the tire, the first area may have a second width in the radial direction, the second area may have a third width in the radial direction, the second width may be in a range of about 25% to about 55% of the first width, and the third width may be in a range of about 25% to about 55% of the first width.

The tire side section may include a pair of sidewalls mounted on the wheel, and at least one of the sidewalls may include the first area and the second area.

The discontinuous recesses may include dimpled patterns.

Each of the dimpled patterns may include one of a polygon and a circle.

The dimpled patterns may be arranged in the second area in the circumferential direction and a radial direction of the tire.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of an exemplary embodiment of a wheel assembly constructed according to the principles of the invention.

FIG. 2 is a side view of the tire of FIG. 1.

FIG. 3 is a cross-sectional view taken along line of FIG. 1 illustrating a portion of an exemplary embodiment of the tire.

FIG. 4 is an enlarged view of portion A of FIG. 2 illustrating an exemplary embodiment of the dimpled area.

FIG. 5 is an enlarged view of portion A of FIG. 2 illustrating another exemplary embodiment of the dimpled area.

FIG. 6 is a cross-sectional view taken along line of FIG. 1 illustrating air flow around a tire and a vehicle wheel.

FIG. 7 is a cross-sectional view illustrating air flow around a dimpled area.

FIG. 8 is a cross-sectional view taken along line of FIG. 1 illustrating a portion of another exemplary embodiment of the tire.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

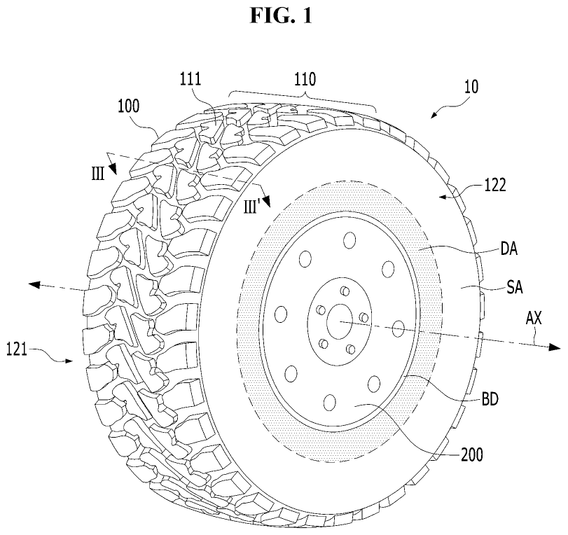

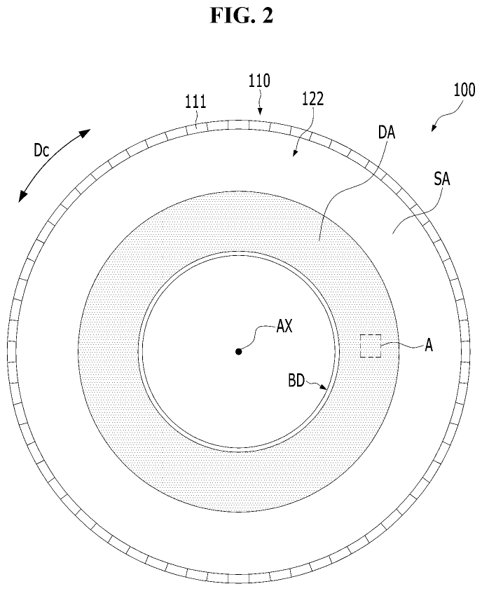

FIG. 1 is a perspective view of an exemplary embodiment of a wheel assembly constructed according to the principles of the invention. FIG. 2 is a side view of the tire of FIG. 1.

Referring to FIGS. 1 and 2, a wheel assembly 10 includes a tire 100 and a rim wheel 200. The tire 100 is mounted on the rim wheel 200 and rolls with the rim wheel 200.

The tire 100 may include a tread section 110 and a tire side section which is in the form of a pair of first and second sidewalls 121 and 122 extending from the tread section 110 to a bead BD. In an exemplary embodiment, the tire 100 may be a pneumatic tire.

The tread section 110 is positioned at the outermost circumferential surface of the tire 100 to come into contact with ground. The tread section 110 may be configured to deliver a driving force and a braking force of the rim wheel 200 and/or a corresponding vehicle to the ground. The tread section 110 includes a thick rubber layer having tread patterns 111 for steering stability, traction, and braking.

The tread patterns 111 are protruded from the surface of the tire section 110 to contact the ground, and are configured to deliver the driving force and the braking force of the rim wheel 200 and/or the vehicle to the ground. The tread patterns 111 may define grooves for drainage while driving over wet roads. The grooves may include a groove extending in a circumferential direction Dc about an axis AX of the tire 100 and/or the wheel assembly 10 and a groove extending in a width direction of the tread section 110. The tread patterns 111 may include sipes for improving traction force and braking force. The sipes may be smaller than the grooves. The sipes may improve the driving force and the braking force of the tire 100 by sucking moisture and cutting off the layer of water while driving over wet roads.

Each of the first and second sidewalls 121 and 122 extends from an end of the tread section 110 which is, for example, a tire shoulder. Each of the first and the second sidewalls 121 and 122 may provide lateral stability for the tire 100, and may transmit engine torque from the rim wheel 200 to the tread section 110. In addition, each of the first and the second sidewalls 121 and 122 may perform a bending and stretching motion to increase ride comfort. Each of the first and second sidewalls 121 and 122 may have a symmetric structure with respect to the tread section 110 or a plane perpendicular to the width direction of the tread section 110.

At least one of the first and the second sidewalls 121 and 122 includes a first circumferential area, which is in the form of a smooth area SA and a second circumferential area, which is in the form of a dimpled area DA. The second circumferential area includes discontinuous recesses in an outer surface of the at least one of the first and the second the sidewalls 121 and 122.

The smooth area SA may extend in the circumferential direction Dc with substantially equal radii from the axis AX. The smooth area SA may be adjacent to the tread section 110. The smooth area SA may extend from the tread section 110 to the dimpled area DA, and accordingly may be continuous with the tread section 110 and the dimpled area DA.

The smooth area SA may have a substantially smooth surface. Alternatively, the smooth area SA may include protrusions having a height of about 1 millimeter or less from the surface of the smooth area SA. For example, the protrusions of the smooth area SA may be visible for tire information lettering.

The dimpled area DA may extend in the circumferential direction Dc with substantially equal radii from the axis AX. The dimpled area DA may be disposed between the smooth area SA and the bead BD. The dimpled area DA may extend from the smooth area SA to the bead BD, and accordingly may be continuous with the smooth area SA and the bead BD.

The dimpled area DA is shown as being provided in the second sidewall 122 in FIGS. 1 and 2, and the dimpled area DA may also be provided in the first side wall 121.

In an exemplary embodiment, the dimpled area DA may be adjacent to the bead BD without an intervening area. However, exemplary embodiments are not limited thereto. For example, an additional area may be disposed between the dimpled area DA and the bead BD for tire information lettering.

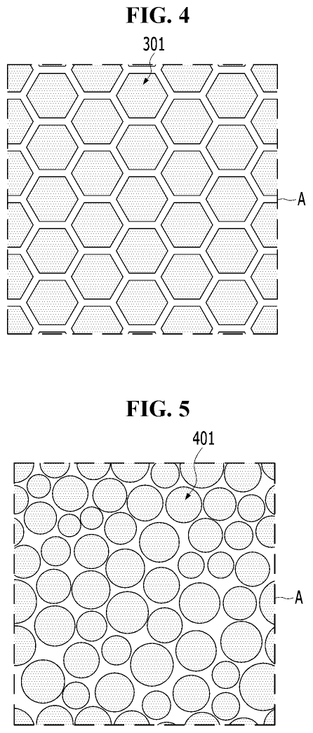

The dimpled area DA includes the discontinuous recesses formed without extending in the circumferential direction Dc and in a radial direction of the tire 100. In an exemplary embodiment, the discontinuous recesses may include dimpled patterns. This will be described in more detail with reference to FIGS. 4 and 5.

Each of the first and second sidewalls 121 and 122 may further include an interface area contacting the rim wheel 200, which is in the form of the bead BD. The bead BD is provided along the circumferential direction Dc. The bead BD may contact and be engaged with the rim wheel 200, and may enable the tire 100 to be mounted on the rim wheel 200. For example, the rim wheel 200 may include a rim flange adjacent to the first and second sidewalls 121 and 122 and the bead BD may have a shape suitable for being engaged with the rim flange of the rim wheel 200. In an exemplary embodiment, the bead BD may include a bead core having a plurality of rubber-coated steel wires and a bead filler having a rubber adhering to the bead core.

The tire 100 may further include a carcass layer positioned inside the tread section 110 and the first and second sidewalls 121 and 122 and forms the framework of the tire 100. The carcass layer may define a tire chamber inside the tire 100, and may maintain air pressure of the tire chamber to endure load and impact on the tire 100. In an exemplary embodiment, the carcass layer may include a plurality of layers overlapping each other. However, exemplary embodiments are not limited thereto. For example, the carcass layer may include a single layer.

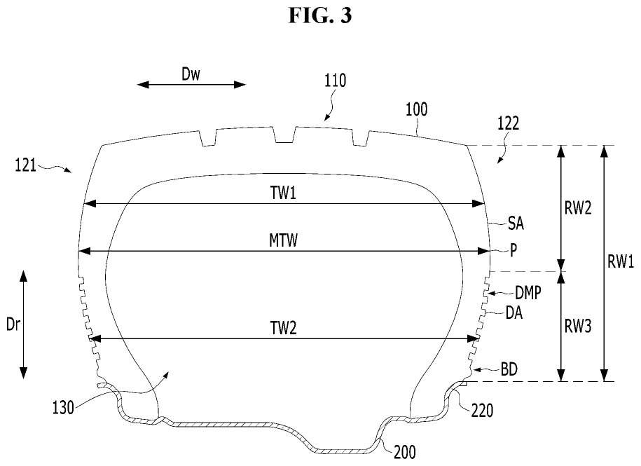

FIG. 3 is a cross-sectional view taken along line of FIG. 1 illustrating a portion of an exemplary embodiment of the tire.

Referring to FIG. 3, the tire 100 is mounted on the rim wheel 200. The bead BD may have a shape suitable for being engaged with a rim flange 220 of the rim wheel 200. A tire chamber 130 filled with air may be defined by the carcass layer disposed inside the tread section 110 and the first and the second sidewalls 121 and 122 and/or the rim wheel 200.

The first and the second sidewalls 121 and 122 extend from both sides of the tread section 110 to the bead BD. Each of the first and the second sidewalls 121 and 122 may include the smooth area SA and the dimpled area DA.

The smooth area SA may be disposed between the tread section 110 and the dimpled area DA. In an exemplary embodiment, the pair of the first and the second sidewalls 121 and 122 may have a first tire width TW1 in a width direction Dw of the tread section 110 at a point of the smooth area SA, and the smooth area SA may include an area in which the first tire width TW1 increases as a distance between the point of the area and the bead BD decreases. Given that the smooth area SA is adjacent to the tread section 110 and the first tire width TW1 increases as getting closer to the bead BD until reaching MTW, air pressure on the smooth area SA may be relatively high when the vehicle moves. Accordingly, the smooth area SA may have a substantially smooth surface to enable air to flow smoothly along the smooth area SA, thereby reducing the air drag on the smooth area SA.

The dimpled area DA may be disposed between the smooth area SA and the bead BD. In an exemplary embodiment, the pair of the first and second sidewalls 121 and 122 may have a second tire width TW2 in the width direction Dw at a point of the dimpled area DA, and the dimpled area DA may include an area in which the second tire width TW2 decreases as a distance between the point of the area and the bead BD decreases such that the bead BD may be mounted on the rim wheel 200. The rim wheel 200 may have a width less than the second tire width TW2.

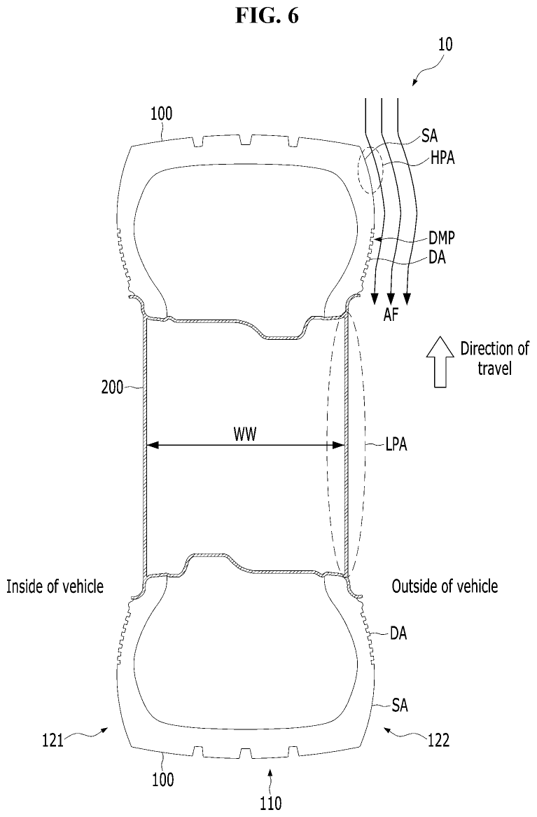

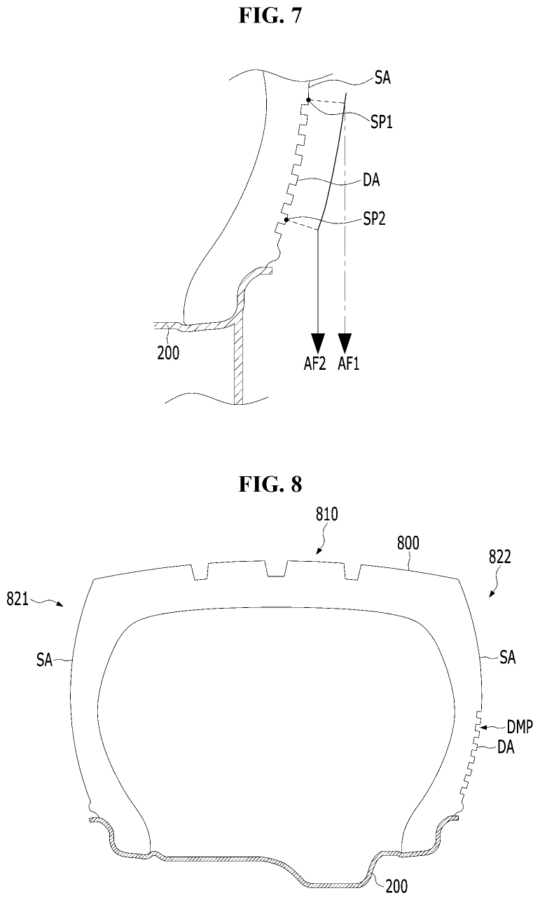

As such, the dimpled area DA and the rim wheel 200 have a generally concave outer surface, and this may cause a low air pressure area occurring around the rim wheel 200 when the vehicle moves. The dimpled area DA may include discontinuous recesses, such as dimpled patterns DMP, formed without extending the circumferential direction Dc and a radial direction Dr of the tire 100. The discontinuous recesses of the dimpled area DA may move the point of flow separation towards the rim wheel 200, and thus reduce the low air pressure area which may be one of sources of aerodynamic drag when the vehicle moves. This will be described in more detail with reference to FIGS. 6 and 7.

The pair of the first and second sidewalls 121 and 122 may have a maximum tire width MTW in the width direction Dw at a point P. The point P may be located in the smooth area SA. Alternatively, the point P may be located in the dimpled area DA. Each of the first and second sidewalls 121 and 122 may have a first radial width RW1 in the radial direction Dr, the smooth area SA may have a second radial width RW2 in the radial direction Dr, and the dimpled area DA or dimpled area DA and the bead BD may have a third radial width RW3 in the radial direction Dr. In this case, the third radial width RW3 may be in a range of about 25% to about 55% of the first radial width RW1 and the smooth area SA may occupy the rest of the first radial width RW1. The second radial width RW2 may be in a range of about 25% to about 55% of the first radial width RW1, and the dimpled area DA and the bead BD may occupy the rest of the first radial width RW1. Here, the first radial width RW1 may be defined as a distance between a boundary where the smooth area SA abuts the tread section 110 and a separation point between the bead BD and the rim flange 220, the second radial width RW2 may be defined as a distance between the boundary where the smooth area SA abuts the tread section 110 and a boundary between the smooth area SA and the dimpled area DA, and the third radial width RW3 may be defined as a distance between the boundary between the smooth area SA and the dimpled area DA and the separation point between the bead BD and the rim flange 220.

FIG. 4 is an enlarged view of portion A of FIG. 2 illustrating an exemplary embodiment of the dimpled area. FIG. 5 is an enlarged view of portion A of FIG. 2 illustrating another exemplary embodiment of the dimpled area.

The dimpled patterns DMP of FIG. 2 may have various geometries. Referring to FIG. 4, the dimpled patterns may include concave polygons, such as hexagons 301. Referring to FIG. 5, the dimpled patterns may include concave circles 401. The dimpled patterns may be arranged in the circumferential direction Dc and the radial direction Dr. The dimpled patterns may be arranged irregularly.

The dimpled patterns may have regular shapes and/or irregular shapes that are recessed without extending in the circumferential direction Dc and the radial direction Dr such that the point of the flow separation occurring at relatively high vehicle speeds move towards the rim wheel 200 shown in FIG. 3.

FIG. 6 is a cross-sectional view taken along line of FIG. 1 illustrating air flow around a tire and a rim wheel. FIG. 7 is a cross-sectional view illustrating air flow around a dimpled area.

Referring to FIG. 6, the area inside of the vehicle, which is adjacent to the first sidewall 121, may be exposed to relatively less air flow due to the vehicle body, and the area outside of the vehicle, which is adjacent to the second sidewall 122, may be exposed to the relatively high air flow when the wheel assembly 10 rolls to move the vehicle. In FIG. 6, air flow AF is shown as occurring around the second sidewall 122.

The air flow AF may travel along the outer surfaces of the second sidewall 122 and the rim wheel 200. Since the smooth area SA is adjacent to the tread section 110, a high air pressure area HPA may occur around the smooth area SA due to the air flow AF.

The rim wheel 200 may have a wheel width WW less than the maximum tire width MTW and/or the second tire width TW2 shown in FIG. 3. As such, the wheel assembly 10 may have a concave area corresponding to the outer side surfaces of the rim wheel 200 and neighboring portions of the first and second sidewalls 121 and 122. The concave area may cause flow separation of the air flow AF, and a low air pressure area LPA may occur according to the flow separation of the air flow AF. The low air pressure area LPA may be a source of aerodynamic drag especially at relatively high vehicle speeds.

The low air pressure area LPA may be reduced by the dimpled patterns DMP of the dimpled area DA adjacent to the rim wheel 200. Referring to FIG. 7 together with FIG. 6, if the second sidewall 122 does not include the dimpled patterns DMP adjacent to the rim wheel 200, air flow AF1 may be separated from the second sidewall 122 at a first separation point SP1 of the second sidewall 122 due to the concave area. For example, the first separation point SP1 may be positioned in an area where the tire width decreases as a distance from the rim wheel decreases.

The dimpled patterns DMP of the dimpled area DA disposed in the concave area may move a point of the flow separation towards the rim wheel 200. On the dimpled area DA, air flow AF2 may be separated from the second sidewall 122 at a second separation point SP2 of the second sidewall 122 where the second separation point SP2 is closer to the rim wheel 200 than the first separation point SP1. The air flow AF2 may be understood as a representative of the air flow AF of FIG. 6. The dimpled patterns DMP may generate local turbulences forcing the air flow AF2 to delay its flow separation from the second sidewall 122, and therefore the second separation point SP2 may be closer to the rim wheel 200 than the first separation point SP1. The low air pressure area LPA may be caused by the second separation point SP2, which means that the low air pressure area LPA may be reduced. As such, the dimpled patterns DMP may move the point of the flow separation toward the rim wheel 200, and reduce the low air pressure area LPA around the rim wheel 200. Accordingly, the aerodynamic drag caused by the low air pressure area LPA may also be reduced. As such, the dimpled area DA is disposed adjacent to the rim wheel 200 to reduce the flow separation, and the smooth area SA is disposed adjacent to the tread section 110 which meets the incoming airflow to reduce air drag, thereby maximizing the efficiency gains of both smooth and dimpled surfaces. Also, the vehicle including the wheel assembly 10 may have improved fuel efficiency.

FIG. 8 is a cross-sectional view taken along line of FIG. 1 illustrating a portion of another exemplary embodiment of the tire.

Referring to FIG. 8, a tire 800 includes a tread section 810, a first sidewall 821, and a second sidewall 822. The tread section 810 and the second sidewall 822 may be configured the same as the tread section 110 and the second sidewall 122 described with reference to FIG. 3.

Only one of the first and the second sidewalls 821 and 822 may include a dimpled area DA. The second sidewall 822 may include a smooth area SA and a dimpled area DA having dimpled patterns DMP, but the first sidewall 821 may not include the dimpled area DA. The first sidewall 821 may not have an outer surface symmetrical to the second sidewall 822. The tire 800 may be mounted on the rim wheel 200 such that the first sidewall 821 faces an area inside of the vehicle and the second sidewall 822 faces an area outside of the vehicle.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A tire mountable on a vehicle wheel comprising:
a tread section; and
a tire side section to be mounted on the vehicle wheel, the tire side section being continuous with the tread section,
wherein the tire side section comprises:
a first area extending in a circumferential direction with substantially equal radii from an axis of the tire and being adjacent to the tread section; and
a second area extending in the circumferential direction with substantially equal radii from the axis of the vehicle wheel and disposed between the first area and the vehicle wheel,
wherein the second area includes discontinuous recesses in an outer surface of the tire side section.

2. The tire of claim 1, wherein the discontinuous recesses are formed in the second area without extending in the circumferential direction and in a radial direction of the tire, and
wherein the discontinuous recesses move a point of flow separation on the outer surface towards the vehicle wheel when the tire rolls to move.

3. The tire of claim 1, wherein the discontinuous recesses comprise dimpled patterns.

4. The tire of claim 3, wherein each of the dimpled patterns comprises one of a polygon and a circle.

5. The tire of claim 3, wherein the dimpled patterns are arranged in the second area in the circumferential direction and a radial direction of the tire.

6. The tire of claim 1, wherein the first area extends from the tread section to the second area and has a substantially smooth surface.

7. The tire of claim 6, wherein the tire side section has a tire width in a width direction of the tread section at a point of the first area, and the tire width increases as a distance between the point of the first area and the vehicle wheel decreases.

8. The tire of claim 1, wherein the first area extends from the tread section to the second area and comprises a protrusion having a height of about 1 millimeter or less.

9. The tire of claim 1, wherein the tire side section further comprises an interface area to be mounted on the vehicle wheel, and the the second area is adjacent to the interface area without an intervening area.

10. The tire of claim 1, wherein the tire side section has a tire width in a width direction of the tread section at a point of the second area, and the tire width decreases as a distance between the point of the second area and the vehicle wheel decreases.

11. The tire of claim 1, wherein:
the tire side section has a first width in a radial direction of the tire;
the first area has a second width in the radial direction;
the second area has a third width in the radial direction;
the second width is in a range of about 25% to about 55% of the first width; and
the third width is in a range of about 25% to about 55% of the first width.

12. The tire of claim 1, wherein the tire side section comprises a pair of sidewalls, and at least one of the sidewalls includes the first area and the second area.

13. A wheel assembly for a vehicle comprising a wheel and a tire mounted on the wheel, wherein the tire comprises:
a tread section; and
a tire side section mounted on the wheel, the tire side section being continuous with the tread section,
wherein the tire side section comprises:
a first area extending in a circumferential direction of the tire with substantially equal radii from an axis of the wheel and being adjacent to the tread section; and
a second area extending in the circumferential direction with substantially equal radii from the axis of the wheel and disposed between the first area and the wheel, the second area including discontinuous recesses in an outer surface of the tire side section.

14. The wheel assembly of claim 13, wherein:
the tire side section has a tire width in a width direction of the tread section at a point of the second area, the tire width decreasing as a distance between the point of the second area and the wheel decreases; and
the wheel has a wheel width in the width direction, the wheel width being less than the tire width.

15. The wheel assembly of claim 14, wherein the discontinuous recesses are formed in the second area without extending in the circumferential direction and in a radial direction of the tire to reduce a low pressure area caused by the wheel width less than the tire width when the wheel assembly rolls to move.

16. The wheel assembly of claim 13, wherein:
the tire side section has a first width in a radial direction of the tire;
the first area has a second width in the radial direction;
the second area has a third width in the radial direction;
the second width is in a range of about 25% to about 55% of the first width; and
the third width is in a range of about 25% to about 55% of the first width.

17. The wheel assembly of claim 13, wherein the tire side section comprises a pair of sidewalls mounted on the wheel, and at least one of the sidewalls includes the first area and the second area.

18. The wheel assembly of claim 13, wherein the discontinuous recesses comprise dimpled patterns.

19. The wheel assembly of claim 18, wherein each of the dimpled patterns comprises one of a polygon and a circle.

20. The wheel assembly of claim 18, wherein the dimpled patterns are arranged in the second area in the circumferential direction and a radial direction of the tire.
